(19) United States
(12) Patent Application Publication
(10) Pub. No.: US 2024/0289470 A1
(43) Pub. Date: Aug. 29, 2024

(54) AUTOMATED USER ACCESS REVIEW SYSTEM

(71) Applicant: Snowflake Inc., Bozeman, MT (US)

(72) Inventors: Andrew Clauson, Orinda, CA (US); Martin S. Heyder, New Orleans, LA (US); Shiva Dutt Paladugu, Guntur (IN); Falguni Sonawala, Redwood City, CA (US); Cameron Tekiyeh, San Francisco, CA (US)

(21) Appl. No.: 18/173,609

(22) Filed: Feb. 23, 2023

(51) Int. Cl. G06F 21/60; G06F 21/62

(52) U.S. Cl. CPC G06F 21/604; G06F 21/6227; G06F 2221/2113; G06F 2221/2141

(57) ABSTRACT

Provided herein are systems and methods for configuring user access review (UAR). A system includes at least one hardware processor coupled to a memory and configured to retrieve user data associated with a plurality of users of a database system. The user data includes current access privileges and a role of a plurality of roles assigned to each user of the plurality of users. The policy data is associated with the plurality of users and includes a list of allowed access privileges for each of the plurality of roles. A mismatch between the current access privileges of a user of the plurality of users and the allowed access privileges associated with the role of the user is detected. A remediation action is performed to adjust the current access privileges of the user based on the detected mismatch. A notification is generated to confirm the remediation action is performed.

### TECHNICAL FIELD

Embodiments of the disclosure relate generally to user access configurations and, more specifically, to techniques for user access review (UAR) in a database system.

### BACKGROUND

Databases are widely used for data storage and access in computing applications. A goal of database storage is to provide enormous sums of information in an organized manner so that it can be accessed, managed, updated, and shared. In a database, data may be organized into rows, columns, and tables. Databases are used by various entities and companies for storing information that may need to be accessed or analyzed.

Cloud-based data warehouses and other cloud database systems or data platforms may need to adhere to various regulatory requirements for cloud products and services, such as regulations from the National Institute for Standards and Technology (NIST), the Health Insurance Portability and Accountability Act (HIPAA), Payment Card Industry Data Security Standard (PCI DSS), the Federal Risk and Authorization Management Program (FedRAMP), and the Sarbanes-Oxley Act (SOX) related to user access reviews. The ultimate goal of user access reviews is to reduce security risk by ensuring that user access is appropriate and limited to legitimate current use cases. However, as companies grow in terms of employees and systems, performing these reviews quarterly and adhering to compliance with such regulations can become time-consuming, cumbersome, and error-prone in the absence of automation.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a network-based database system in communication with a cloud storage platform, according to some example embodiments.

FIG. 2 is a block diagram illustrating the components of a compute service manager, according to some example embodiments.

FIG. 3 is a block diagram illustrating components of an execution platform, according to some example embodiments.

FIG. 4 is a block diagram illustrating an example data flow for user access review (UAR) automation which can be configured using a UAR manager within the network-based database system of FIG. 1, according to some example embodiments.

FIG. 5 and FIG. 6 illustrate flow diagrams of example functions associated with UAR automation using multiple access portals, according to some example embodiments.

FIG. 7 illustrates a flow diagram of a method for access revocation associated with UAR, according to some example embodiments.

FIG. 8, FIG. 9, FIG. 10, and FIG. 11 illustrate example user interfaces that can be configured in connection with UAR automation using a UAR manager, according to some example embodiments.

FIG. 12 is a flow diagram illustrating the operations of a database system in performing a method for configuring user access review, according to some example embodiments.

FIG. 13 illustrates a diagrammatic representation of a machine in the form of a computer system within which a set of instructions may be executed for causing the machine to perform any one or more of the methodologies discussed herein, according to some example embodiments.

### DETAILED DESCRIPTION

Reference will now be made in detail to specific example embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

In the present disclosure, physical units of data that are stored in a data platform—and that make up the content of, e.g., database tables in customer accounts—are referred to as micro-partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internal to the data platform, a given file is referred to herein as an “internal file” and may be stored in (or at, or on, etc.) what is referred to herein as an “internal storage location.” If stored external to the data platform, a given file is referred to herein as an “external file” and is referred to as being stored in (or at, or on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, extensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

In a typical implementation, a data platform may include one or more databases that are respectively maintained in association with any number of customer accounts (e.g., accounts of one or more data providers), as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata (e.g., account object metadata) in association with the data platform in general and in association with, for example, particular databases and/or particular customer accounts as well. Users and/or executing processes that are associated with a given customer account may, via one or more types of clients, be able to cause data to be ingested into the database, and may also be able to manipulate the data, add additional data, remove data, run queries against the data, generate views of the data, and so forth. As used herein, the terms “account object metadata” and “account object” are used interchangeably.

In an implementation of a data platform, a given database (e.g., a database maintained for a customer account) may reside as an object within, e.g., a customer account, which may also include one or more other objects (e.g., users, roles, grants, shares, warehouses, resource monitors, integrations, network policies, and/or the like). Furthermore, a given object such as a database may itself contain one or more objects such as schemas, tables, materialized views, and/or the like. A given table may be organized as a collection of records (e.g., rows) so that each includes a plurality of attributes (e.g., columns). In some implementations, database data is physically stored across multiple storage units, which may be referred to as files, blocks, partitions, micro-partitions, and/or by one or more other names. In many cases, a database on a data platform serves as a backend for one or more applications that are executing on one or more application servers.

The disclosed UAR techniques can be configured and performed by a UAR manager in a network-based database system to orchestrate a control procedure for reviewing user (e.g., employee) access to secure systems, evaluating if such access is appropriate (e.g., allowed), and making changes accordingly (e.g., revoke or grant access). The disclosed UAR techniques include access review which is performed in a reputable manner, generating evidence (e.g., reports or notifications) of the access review process and remediation actions that can be shared with outside auditors. For example, if access to a system is no longer needed by a user, such access can be revoked using the disclosed UAR techniques, and the outcome of the remediation action (e.g., the revocation of the user access) can be verified and shared with an auditor.

Additionally, the disclosed UAR techniques can be used to facilitate adherence to compliance with regulatory requirements including NIST, HIPAA, PCI DSS, FedRAMP, and SOX requirements. In some aspects, the disclosed UAR techniques are used to (a) expose persistent and inappropriate access to systems; (b) provide a mechanism to accurately validate the appropriateness of access to critical business systems; (c) automate tedious/error-prone tasks of manually creating tickets to remove access; (d) streamline the cumbersome review process for compliance managers; and (e) provide UAR reviewers with information for making an informed decision about configuring (e.g., removing) user access.

Conventional techniques for access control include an individual review of spreadsheets, which is time-consuming and inefficient. For example, if user access has to be revoked, multiple teams perform relevant data entry, verification, and revocation handling. Since multiple teams are involved with a single-user access revocation, such a process is prone to erroneous access revocation, erroneous triage of access revocation tickets, or missed access revocations.

The UAR techniques can be used to configure the following features associated with UAR: a manager portal (e.g., to provide a view of all users and corresponding roles and entitlements), a security compliance portal (e.g., to manage a review cycle and monitor progress and completion), handling of bulk actions and filters (e.g., approve or reject privileges for multiple users at the same time), delegation (e.g., delegate reviews to other users), role definition and role-based access control (RBAC) overlay (e.g., to highlight exceptions and help managers make better decisions), auto-revocation and validation (e.g., trigger access removal upon review completion), integration and scalability with systems and users, and capturing and preserving the history of all user changes (e.g., using “time travel”-related functionality and tasks).

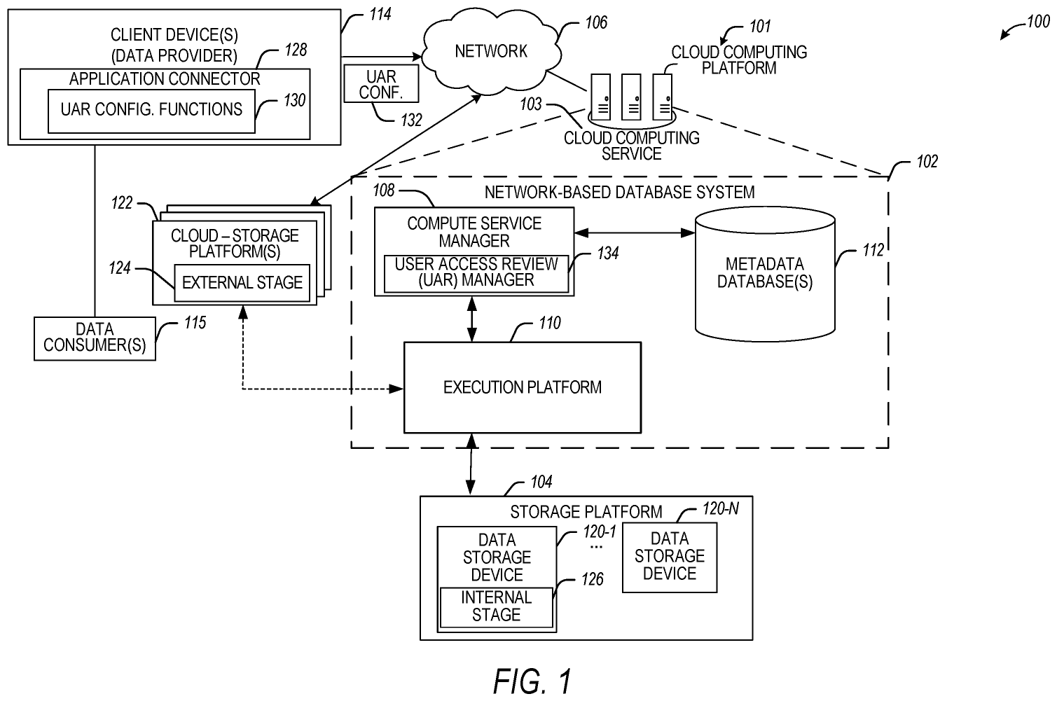

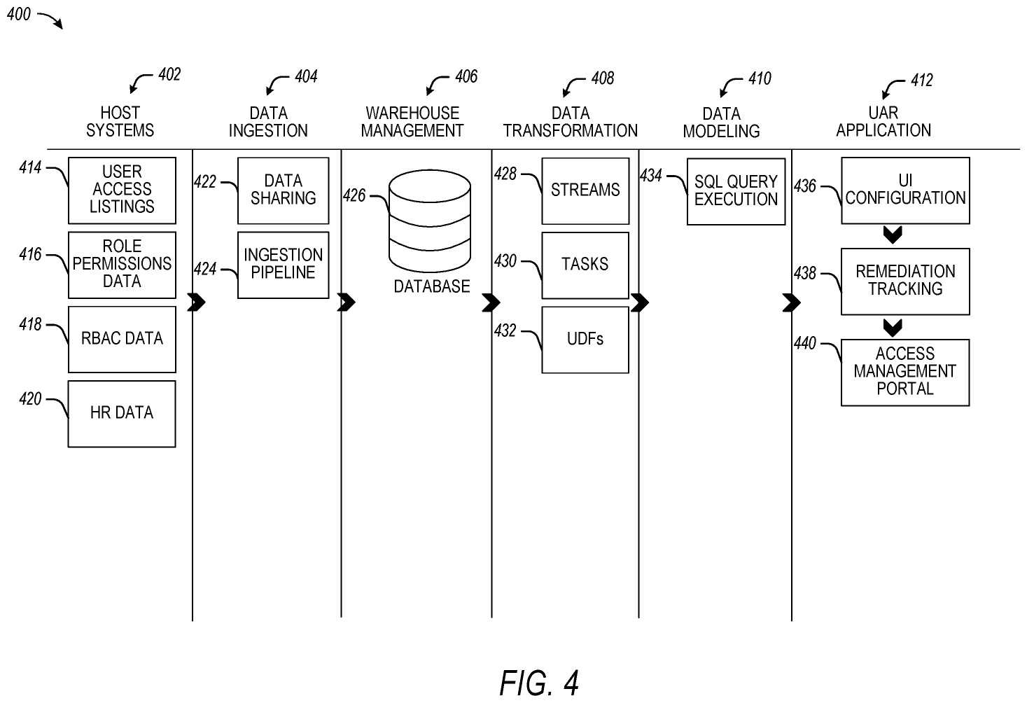

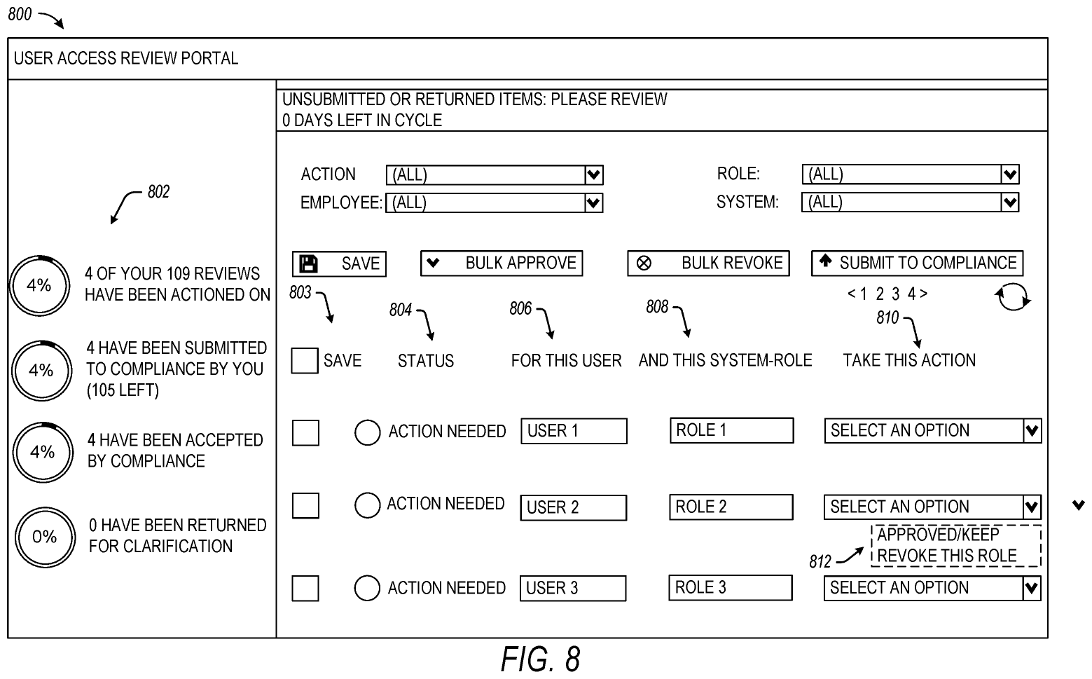

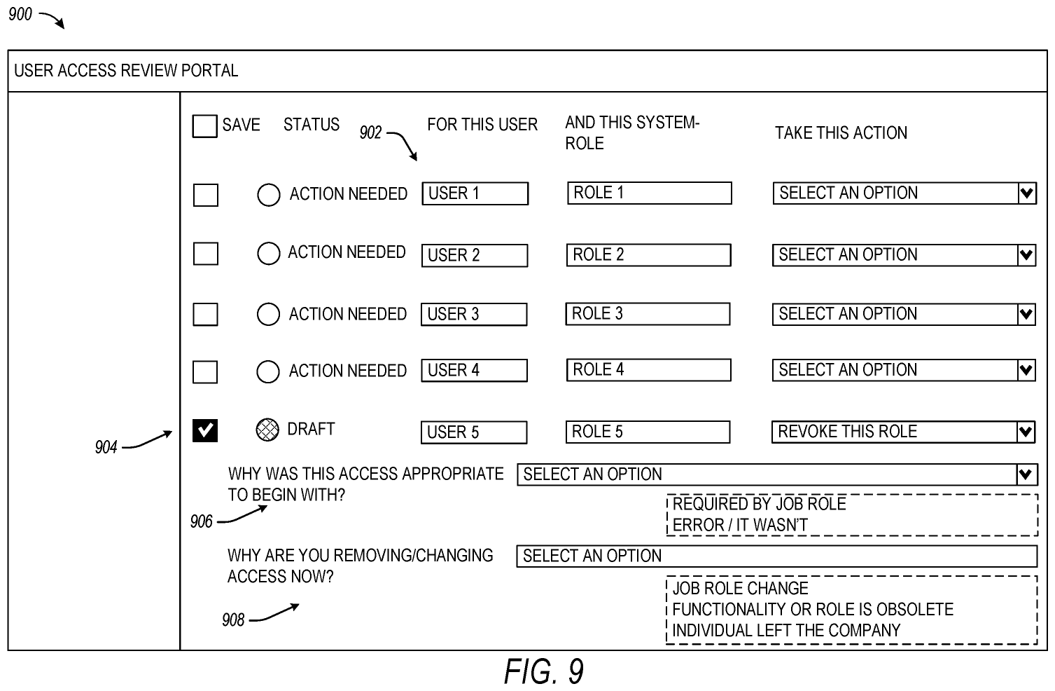

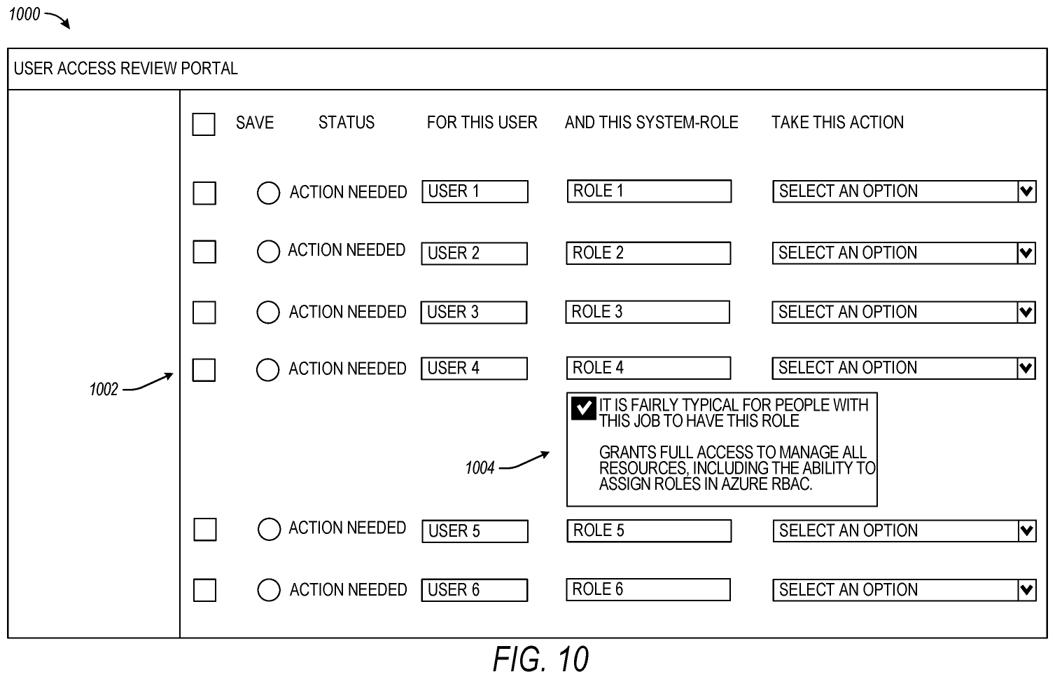

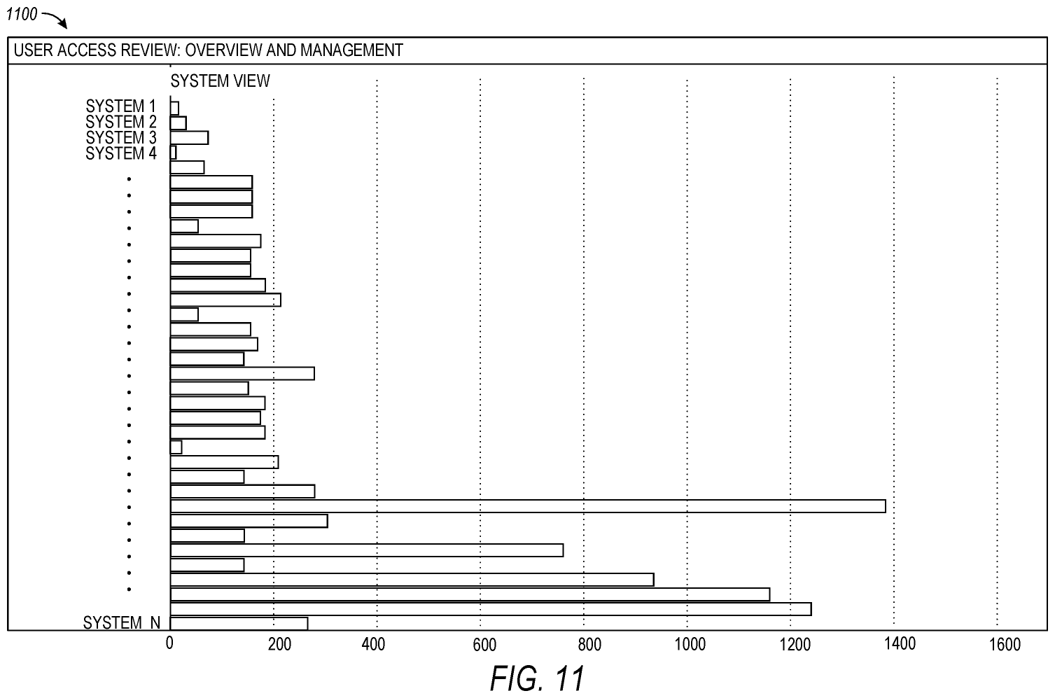

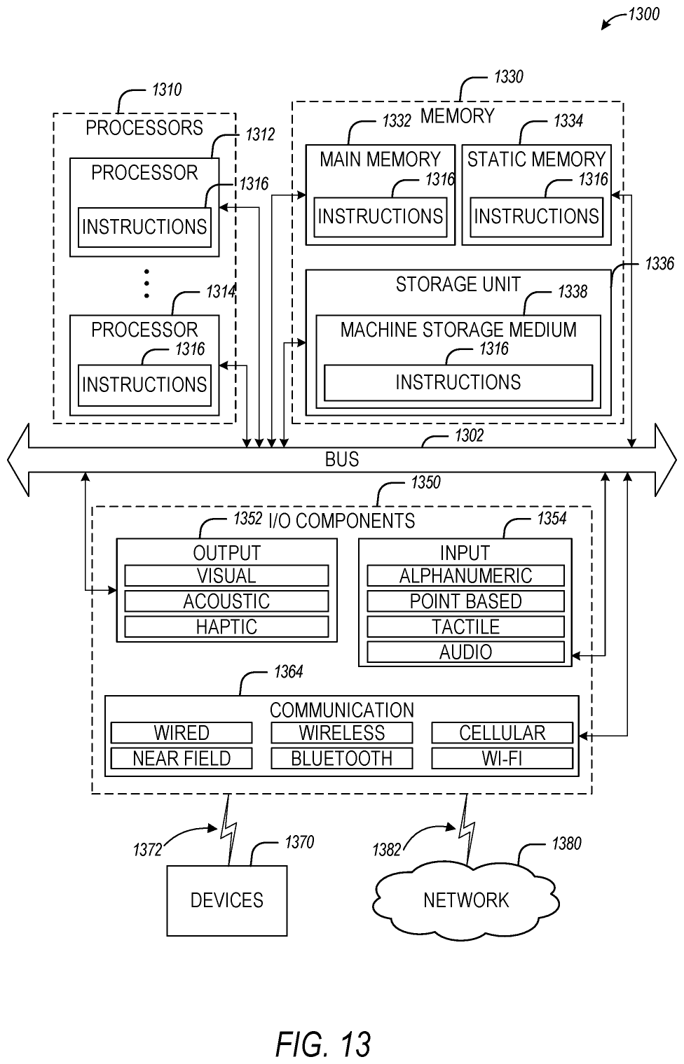

The various embodiments that are described herein are described with reference where appropriate to one or more of the various figures. An example computing environment including a UAR manager configured to perform UAR-related functions is discussed in connection with FIGS. 1-3. Example UAR data flows and other UAR functionalities associated with the UAR manager are discussed in connection with FIGS. 4-7 and FIG. 12. Example user interfaces that can be configured in connection with UAR automation using a UAR manager are illustrated in FIG. 8-FIG. 11 illustrate A more detailed discussion of example computing devices that may be used with the disclosed techniques is provided in connection with FIG. 13.

FIG. 1 illustrates an example computing environment 100 that includes a database system in the example form of a network-based database system 102, according to some example embodiments. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other embodiments, the computing environment may comprise another type of network-based database system or a cloud data platform. For example, in some aspects, the computing environment 100 may include a cloud computing platform 101 with the network-based database system 102, and a storage platform 104 (also referred to as a cloud storage platform). The cloud computing platform 101 provides computing resources and storage resources that may be acquired (purchased) or leased and configured to execute applications and store data.

The cloud computing platform 101 may host a cloud computing service 103 that facilitates storage of data on the cloud computing platform 101 (e.g., data management and access) and analysis functions (e.g. SQL queries, analysis), as well as other processing capabilities (e.g., configuring replication group objects as described herein). The cloud computing platform 101 may include a three-tier architecture: data storage (e.g., storage platforms 104 and 122), an execution platform 110 (e.g., providing query processing), and a compute service manager 108 providing cloud services.

It is often the case that organizations that are customers of a given data platform also maintain data storage (e.g., a data lake) that is external to the data platform (i.e., one or more external storage locations). For example, a company could be a customer of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The customer's servers and cloud-storage platforms are both examples of what a given customer could use as what is referred to herein as an external storage location. The cloud computing platform 101 could also use a cloud-storage platform as what is referred to herein as an internal storage location concerning the data platform.

From the perspective of the network-based database system 102 of the cloud computing platform 101, one or more files that are stored at one or more storage locations are referred to herein as being organized into one or more of what is referred to herein as either “internal stages” or “external stages.” Internal stages are stages that correspond to data storage at one or more internal storage locations, and where external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location—i.e., in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based database system 102 of the cloud computing platform 101 is in communication with the cloud storage platforms 104 and 122 (e.g., AWS®, Microsoft Azure Blob Storage®, or Google Cloud Storage). The network-based database system 102 is a network-based system used for reporting and analysis of integrated data from one or more disparate sources including one or more storage locations within the cloud storage platform 104. The cloud storage platform 104 comprises a plurality of computing machines and provides on-demand computer system resources such as data storage and computing power to the network-based database system 102.

The network-based database system 102 comprises a compute service manager 108, an execution platform 110, and one or more metadata databases 112. The network-based database system 102 hosts and provides data reporting and analysis services to multiple client accounts.

The compute service manager 108 coordinates and manages operations of the network-based database system 102. The compute service manager 108 also performs query optimization and compilation as well as managing clusters of computing services that provide compute resources (also referred to as “virtual warehouses”). The compute service manager 108 can support any number of client accounts such as end-users providing data storage and retrieval requests, system administrators managing the systems and methods described herein, and other components/devices that interact with compute service manager 108.

The compute service manager 108 is also in communication with a client device 114. The client device 114 corresponds to a user of one of the multiple client accounts supported by the network-based database system 102. A user may utilize the client device 114 to submit data storage, retrieval, and analysis requests to the compute service manager 108. Client device 114 (also referred to as remote computing device or user device 114) may include one or more of a laptop computer, a desktop computer, a mobile phone (e.g., a smartphone), a tablet computer, a cloud-hosted computer, cloud-hosted serverless processes, or other computing processes or devices may be used (e.g., by a data provider) to access services provided by the cloud computing platform 101 (e.g., cloud computing service 103) by way of a network 106, such as the Internet or a private network. A data consumer 115 can use another computing device to access the data of the data provider (e.g., data obtained via the client device 114).

In the description below, actions are ascribed to users, particularly consumers and providers. Such actions shall be understood to be performed concerning client device (or devices) 114 operated by such users. For example, a notification to a user may be understood to be a notification transmitted to the client device 114, input or instruction from a user may be understood to be received by way of the client device 114, and interaction with an interface by a user shall be understood to be interaction with the interface on the client device 114. In addition, database operations (joining, aggregating, analysis, etc.) ascribed to a user (consumer or provider) shall be understood to include performing such actions by the cloud computing service 103 in response to an instruction from that user.

In some embodiments, the client device 114 is configured with an application connector 128, which may be configured to perform UAR configuration functions 130. For example, the UAR configuration functions 130 are used to generate one or more UAR configurations 132 for communication to the network-based database system 102 via network 106. For example, UAR configurations 132 can be communicated to UAR manager 134 within the compute service manager 108.

The compute service manager 108 is also coupled to one or more metadata databases 112 that store metadata about various functions and aspects associated with the network-based database system 102 and its users. For example, a metadata database 112 may include a summary of data stored in remote data storage systems as well as data available from a local cache. Additionally, a metadata database 112 may include information regarding how data is organized in remote data storage systems (e.g., the cloud storage platform 104) and the local caches. Information stored by a metadata database 112 allows systems and services to determine whether a piece of data needs to be accessed without loading or accessing the actual data from a storage device. In some embodiments, metadata database 112 is configured to store account object metadata (e.g., account objects used in connection with a replication group object).

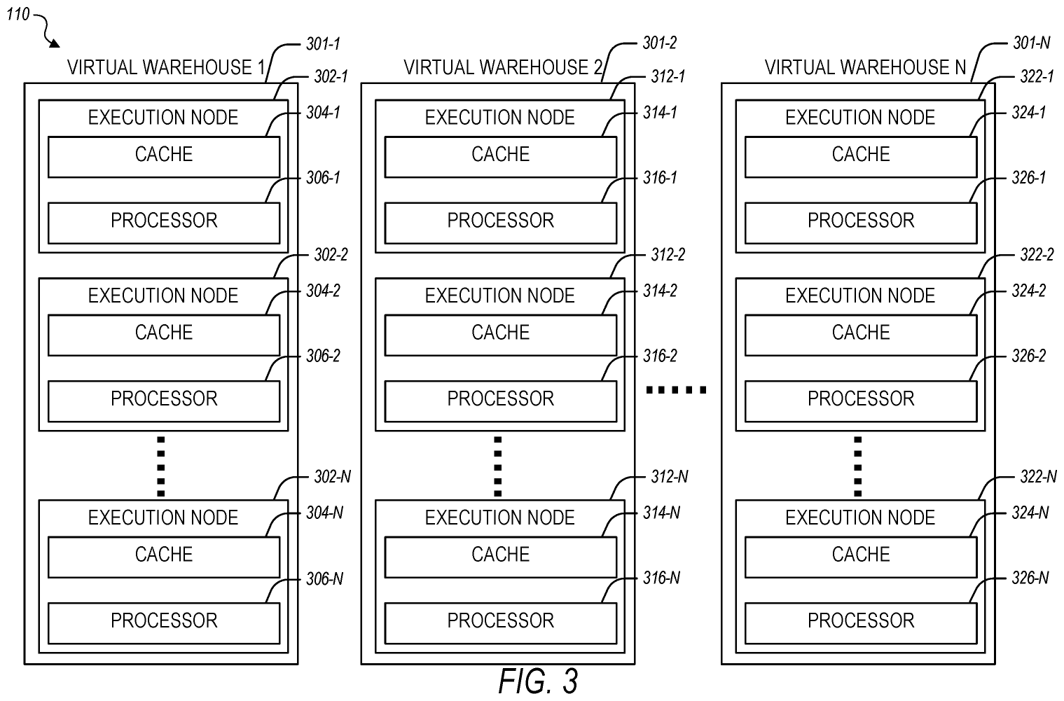

The compute service manager 108 is further coupled to the execution platform 110, which provides multiple computing resources that execute various data storage and data retrieval tasks. As illustrated in FIG. 3, the execution platform 110 comprises a plurality of compute nodes. The execution platform 110 is coupled to storage platform 104 and cloud storage platforms 122. The storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data-storage technology. Additionally, the cloud storage platform 104 may include distributed file systems (such as Hadoop Distributed File Systems (HDFS)), object storage systems, and the like. In some embodiments, at least one internal stage 126 may reside on one or more of the data storage devices 120-1-120-N, and at least one external stage 124 may reside on one or more of the cloud storage platforms 122.

In some embodiments, the compute service manager 108 includes the UAR manager 134. The UAR manager 134 comprises suitable circuitry, interfaces, logic, and/or code and is configured to perform UAR-related functions which can be based (at least partially) on one or more of the UAR configurations 132. For example, the UAR manager 134 can configure one or more of the UAR functionalities discussed in connection with FIGS. 4-12 based on the UAR configurations 132. For example, the UAR configurations 132 can be used to configure data ingestion from host systems (e.g., types of data for ingestion, stage location for om stages storing the data, data transformation, and modeling functions to normalize the ingested data, and one or more configurations associated with the UAR application provided by the UAR manager 134 as discussed in connection with at least FIGS. 4-7). Additionally, the UAR manager 134 can be configured to perform one or more of the UAR functionalities discussed in connection with FIGS. 4-12. For example, the UAR manager 134 can be configured to provide the UAR application functions illustrated in FIG. 4, including remediation tracking and access management.

In some embodiments, communication links between elements of the computing environment 100 are implemented via one or more data communication networks. These data communication networks may utilize any communication protocol and any type of communication medium. In some embodiments, the data communication networks are a combination of two or more data communication networks (or sub-Networks) coupled to one another. In alternate embodiments, these communication links are implemented using any type of communication medium and any communication protocol.

The compute service manager 108, metadata database(s) 112, execution platform 110, and storage platform 104, are shown in FIG. 1 as individual discrete components. However, each of the compute service manager 108, metadata database(s) 112, execution platform 110, and storage platform 104 may be implemented as a distributed system (e.g., distributed across multiple systems/platforms at multiple geographic locations). Additionally, each of the compute service manager 108, metadata database(s) 112, execution platform 110, and storage platform 104 can be scaled up or down (independently of one another) depending on changes to the requests received and the changing needs of the network-based database system 102. Thus, in the described embodiments, the network-based database system 102 is dynamic and supports regular changes to meet the current data processing needs.

During a typical operation, the network-based database system 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the cloud storage platform 104. It is desirable to retrieve as much data as possible from caches within the execution platform 110 because the retrieval speed is typically much faster than retrieving data from the cloud storage platform 104.

As shown in FIG. 1, the cloud computing platform 101 of the computing environment 100 separates the execution platform 110 from the storage platform 104. In this arrangement, the processing resources and cache resources in the execution platform 110 operate independently of the data storage devices 120-1 to 120-N in the cloud storage platform 104. Thus, the computing resources and cache resources are not restricted to specific data storage devices 120-1 to 120-N. Instead, all computing resources and all cache resources may retrieve data from, and store data to, any of the data storage resources in the cloud storage platform 104.

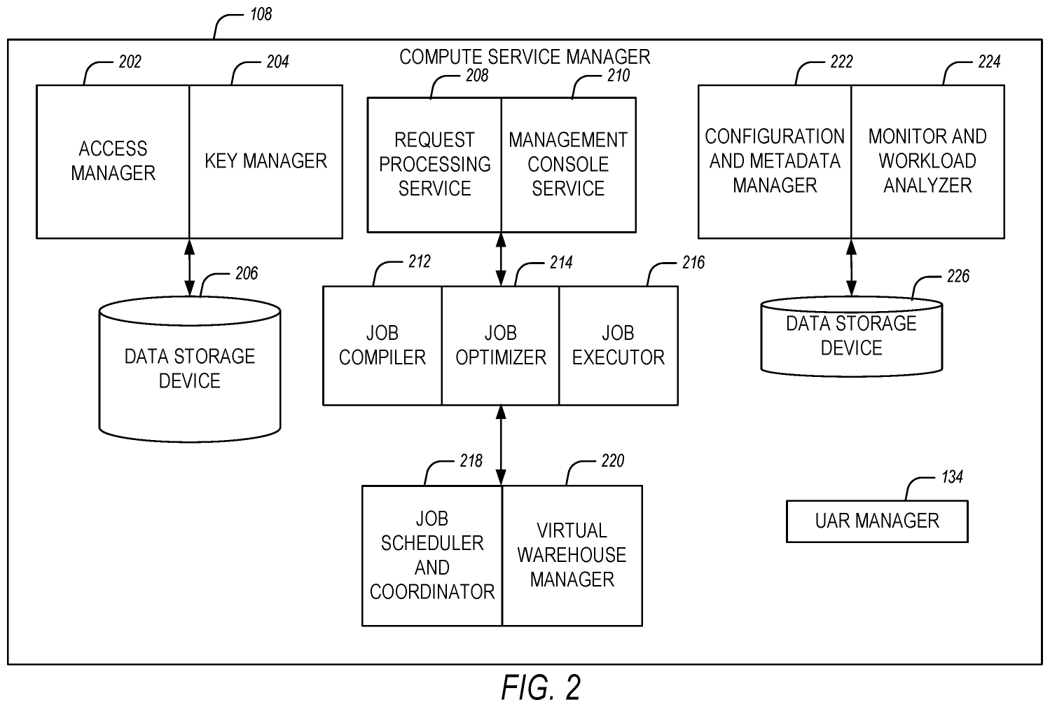

FIG. 2 is a block diagram illustrating components of the compute service manager 108, according to some example embodiments. As shown in FIG. 2, the compute service manager 108 includes an access manager 202 and a key manager 204 coupled to an access metadata database 206, which is an example of the metadata database(s) 112. Access manager 202 handles authentication and authorization tasks for the systems described herein. The key manager 204 facilitates the use of remotely stored credentials to access external resources such as data resources in a remote storage device. As used herein, the remote storage devices may also be referred to as “persistent storage devices” or “shared storage devices.” For example, the key manager 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the key manager 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. Job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an embodiment, the job scheduler and coordinator 218 determines a priority for internal jobs that are scheduled by the compute service manager 108 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries.

Additionally, the compute service manager 108 includes configuration and metadata manager 222, which manages the information related to the data stored in the remote data storage devices and the local buffers (e.g., the buffers in execution platform 110). Configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the network-based database system 102 and may further redistribute tasks based on a user (e.g., “external”) query workload that may also be processed by the execution platform 110. The configuration and metadata manager 222 and the monitor and workload analyzer 224 are coupled to a data storage device 226. The data storage device 226 in FIG. 2 represents any data storage device within the network-based database system 102. For example, data storage device 226 may represent buffers in execution platform 110, storage devices in storage platform 104, or any other storage device.

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing query A should not be allowed to request access to data source D (e.g., data storage device 226) that is not relevant to query A. Similarly, a given execution node (e.g., execution node 302-1 may need to communicate with another execution node (e.g., execution node 302-2), and should be disallowed from communicating with a third execution node (e.g., execution node 312-1) and any such illicit communication can be recorded (e.g., in a log or other location). Also, the information stored on a given execution node is restricted to data relevant to the current query and any other data is unusable, rendered so by destruction or encryption where the key is unavailable.

As previously mentioned, the compute service manager 108 includes the UAR manager 134 configured to perform the disclosed UAR functionalities which are discussed in connection with at least FIGS. 4-12.

FIG. 3 is a block diagram illustrating components of the execution platform 110, according to some example embodiments. As shown in FIG. 3, the execution platform 110 includes multiple virtual warehouses, including virtual warehouse 1 (or 301-1), virtual warehouse 2 (or 301-2), and virtual warehouse N (or 301-N). Each virtual warehouse includes multiple execution nodes that each include a data cache and a processor. The virtual warehouses can execute multiple tasks in parallel by using multiple execution nodes. As discussed herein, the execution platform 110 can add new virtual warehouses and drop existing virtual warehouses in real time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in the cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternative embodiments may include execution nodes containing any number of processors and any number of caches. Additionally, the caches may vary in size among the different execution nodes. The caches shown in FIG. 3 store, in the local execution node, data that was retrieved from one or more data storage devices in the cloud storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity. Further, some nodes may be executing much slower than others due to various issues (e.g., virtualization issues and network overhead). In some example embodiments, the imbalances are addressed at the scan level using a file-stealing scheme. In particular, whenever a node process completes scanning its set of input files, it requests additional files from other nodes. If one of the other nodes receives such a request, the node analyzes its own set (e.g., how many files are left in the input file set when the request is received), and then transfers ownership of one or more of the remaining files for the duration of the current job (e.g., query). The requesting node (e.g., the file stealing node) then receives the data (e.g., header data) and downloads the files from the cloud storage platform 104 (e.g., from data storage device 120-1), and does not download the files from the transferring node. In this way, lagging nodes can transfer files via file stealing in a way that does not worsen the load on the lagging nodes.

Although virtual warehouses 1, 2, and N are associated with the same execution platform 110, virtual warehouses 1, . . . , N may be implemented using multiple computing systems at multiple geographic locations. For example, virtual warehouse 1 can be implemented by a computing system at a first geographic location, while virtual warehouses 2 and N are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location, and execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault-tolerant. For example, if one virtual warehouse fails, that virtual warehouse is quickly replaced with a different virtual warehouse at a different geographic location.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in the cloud storage platform 104, but each virtual warehouse has its execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

FIG. 4 is a block diagram illustrating example data flow 400 for user access review (UAR) automation which can be configured using the UAR manager 134 within the network-based database system of FIG. 1, according to some example embodiments. Referring to FIG. 4, the data flow 400 includes data ingestion 404 using data from host systems 402, managing the ingested data using warehouse management 406 (e.g., database 426 of a network-based database system), performing data transformation 408 and data modeling 410, and configuring a UAR application 412 using the transformed/modeled data. In some aspects, the UAR application can be configured and executed by the UAR manager 134 to create a user interface (UI) (e.g., during UI configuration 436) where identity access data from multiple systems is presented (e.g., to corporate management) for periodic review.

In operation, user data is retrieved from host systems 402 (e.g., different systems or functional entities of a network-based database system). The user data can include user access listings 414 and role permissions data 416. The user access listings 414 include a list of users of the network-based database system and at least one role assigned to each user. The role permissions data 416 includes information on the current permissions (e.g., read or write permissions) for a specific role.

The data retrieved from the host systems 402 further includes role-based access control (RBAC) data 418 which is a policy (e.g., an industry-wide policy set by a regulatory body) indicating the allowed permissions for a specific role. The data retrieved from the host systems 402 further includes human resources (HR) data 420, which indicates (for each user) the organization unit (or system) the user is associated with, who the user reports to, and what role (or roles) the user is assigned to.

During data ingestion 404, the data from host systems 402 is ingested into database 426 using data sharing 422 and at least one data ingestion pipeline 424. At least one data ingestion pipeline 424 can be configured for continuous data ingestion where data can be ingested into database 426 as soon as the data is loaded (stored) in a stage.

The ingested data is normalized during data transformation 408 and data modeling 410. More specifically, the ingested data is processed during data transformation 408 using one or more of streams 428, tasks 430, and user-defined functions (UDFs) 432. During data modeling 410, additional processing is performed using SQL query execution 434. Additionally, the UAR manager 134 uses streams 428, tasks 430, and UDFs 432 to orchestrate a set of workflows during UI configuration 436, remediation tracking 438, and configuring the access management portal 440 to streamline automated UAR processing using the UAR application 412, reduce manual task processing, and prevent any potential end-user errors while upholding compliance commitments within the network-based database system 102.

During UI configuration 436, one or more UIs (e.g., as illustrated in FIGS. 8-11) are presented to a user (e.g., a manager authorized to perform UAR). One or more remediation actions can be indicated (or otherwise requested) via the one or more UIs. For example and as illustrated in FIGS. 8-10, the one or more UIs can present a list of users, their currently assigned role (or roles), and an indication of whether access privileges of such currently assigned role are compliant with access privileges for the role according to RBAC data. In some aspects, the indication of whether such a currently assigned role is compliant with RBAC data can be in the form of using a different color to display the currently assigned role (e.g., the currently assigned role can be displayed in green color if it is aligned with the RBAC data or in red color if it is not). In some aspects, other visual indications on the one or more UIs can be used to indicate a mismatch between the current access privileges of a currently assigned role of a user of the plurality of users and the allowed access privileges associated with the role of the user.

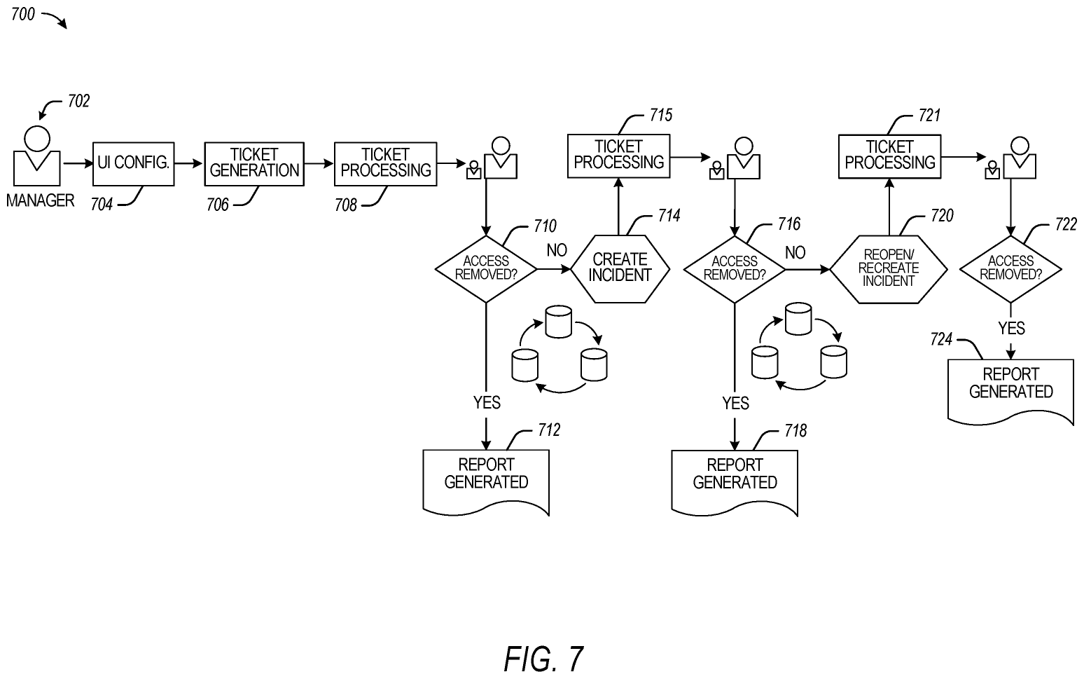

In some aspects, the one or more UIs associated with the UAR application 412 can be used to receive a remediation action selection (e.g., a selection for revoking one or more user access privileges). The UAR manager 134 can also perform remediation tracking 438 to confirm the remediation action is performed. An example flow for automatic revocation of user access and tracking the revocation is complete is illustrated in FIG. 7.

In some aspects, the UAR manager 134 can also configure an access management portal 440 which can be used for entering the remediation action selection, remediation tracking and generating a notification of the performed remediation.

In some aspects, to ensure auditable data, each change to the review data or review metadata is captured at the database level. For example, tasks 430 can be used to compare time travel (or historic) data to history tables via a hash and insert any uncaptured time travel data into a history table. This processing makes the insert task resilient to an error (e.g., a missed insert) as more time travel data is inspected for insertion than is anticipated to be needed for auditing.

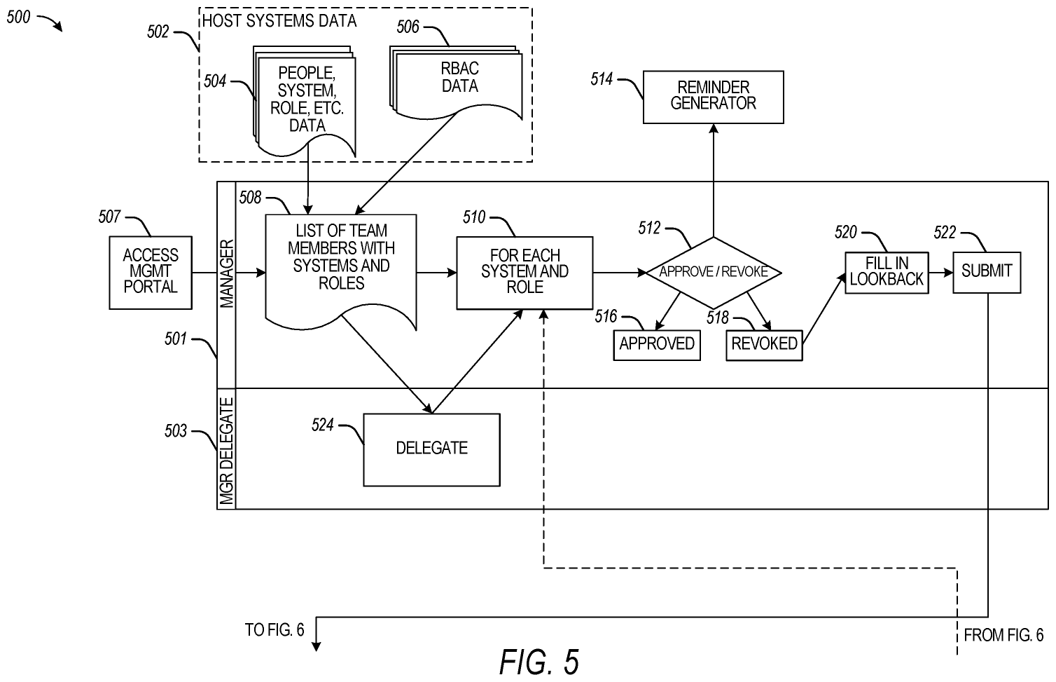

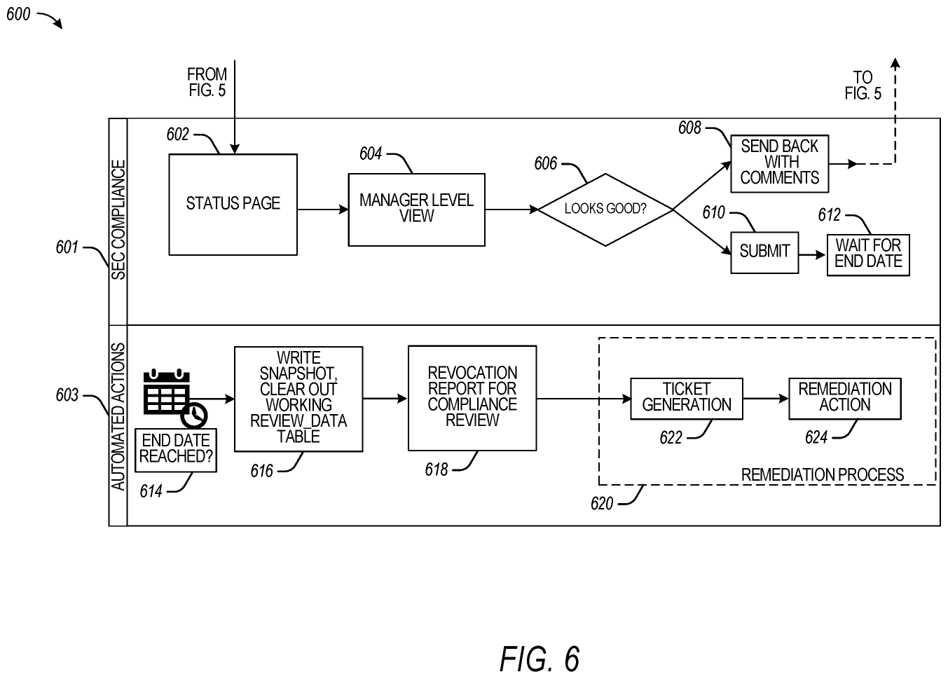

FIG. 5 and FIG. 6 illustrate flow diagrams 500 and 600 of example functions associated with UAR automation using multiple access portals, according to some example embodiments. Referring to FIGS. 5-6, the access management portal 507 can be the same as the access management portal 440. The UAR functionalities of flow diagrams 500 and 600 can be performed by different entities (or user) tiers, including a manager 501, a manager delegate 503, a security compliance officer 601, and automated actions 603 (which can be performed by, e.g., the UAR manager 134).

Once the access management portal 507 is configured, host system data 502 is ingested and a list 508 (of team members/users with their corresponding system involvement and roles) is presented in a UI to the manager. The host system data 502 can include data 504 (e.g., users, systems they are associated with, and the current user roles) and RBAC data 506. In some aspects, the host system data 502 includes the user data retrieved from host systems 402 (e.g., as illustrated in FIG. 4).

The manager 501 can provide input 510 for each system and user role and enter a selection 512, which can include an approval 516 (e.g., for an approved access privilege or role) or a revocation 518 (e.g., for a revoked access privilege or role). Manager 501 can also provide additional lookback information 520 (e.g., via a drop-down menu as illustrated in FIGS. 8-9) and submit the selection at operation 522. In some aspects, a reminder generator 514 can be initiated automatically to provide one or more reminders if selection 512 is not received during a threshold period. In some embodiments, manager 501 can delegate (at operation 524) the selection 512 to a manager delegate 503.

Subsequent UAR processing can be performed by a security compliance officer 601. After the selection is submitted at operation 522, a UI with a status page 602 is generated and presented to the security compliance officer 601. The UI can include a manager-level view 604 of the selections made by manager 501. The security compliance officer 601 can make a determination 606 of whether the manager's selection is acceptable. If not acceptable, the selection is communicated back to the manager with review comments (e.g., at operation 608). If the selection is acceptable, it is submitted (at operation 610) and a timer is initiated at operation 612 for waiting for an end date (e.g., a date when the access privilege change associated with the manager selection becomes effective).

The automated actions 603 can be performed by the UAR manager 134. For example, the UAR manager 134 can detect when the end date is reached (e.g., at operation 614). In some aspects, the UAR manager can generate a review data table with the data from list 508. For example, the data table can include a data object for each user on the list, where each data object includes a start date (e.g., the date when current privileges became effective), an end date (e.g., the date when the access privilege change becomes effective), as well as corresponding review data (e.g., data indicating what are the new access privileges for the user).

At operation 616, after the end date has been reached, the entries from the review data table are cleared and archived (e.g., moved to an archived data table). At operation 618, a revocation report (or another notification) is generated for compliance review. The revocation report can include the list 508 with the corresponding access privilege changes implemented for each user as of the end date.

The requested access privilege changes are implemented during the remediation process 620. For example, one or more tickets are generated during ticket generation 622 (e.g., a ticket to request an access privilege change). A remediation action 624 is performed based on the generated one or more tickets (e.g., to implement the requested access privilege change). In some aspects, the requested access privilege change is access revocation. Example flow of the remediation process 620 is illustrated in greater detail in FIG. 7.

FIG. 7 illustrates a flow diagram of method 700 for access revocation associated with UAR, according to some example embodiments. Referring to FIG. 7, one or more of the operations of method 700 can be configured and performed by the UAR manager 134.

A manager 702 can access a UI generated based on UI configuration 704 (e.g., to view list 508). During ticket generation 706, one or more request tickets are generated for implementing access privilege changes requested by the manager (e.g., remove user access privileges). In some aspects, a single request ticket is generated per system user role. During ticket processing 708, a determination 710 is made on whether the user access privileges have been removed as requested. If the user access privileges have been removed, a report is generated at operation 712. In some embodiments, the determination 710 can be based on a reconciliation script to check if the user who was requested to be removed via a ticket has been removed based on newly ingested data into database 426. If the user access privilege has not been removed, at operation 714, an incident ticket is generated for ticket processing 715. In some aspects, the incident ticket has higher priority than the request ticket generated during ticket generation 706.

During ticket processing 715 of the incident ticket, a determination 716 is made on whether the user access privileges have been removed as requested. If the user access privileges have been removed, a report is generated at operation 718. If the user access privilege has not been removed, at operation 720, the prior incident ticket is re-opened or a new (second) incident ticket is generated for ticket processing 721. During ticket processing 721 of the incident ticket, a determination 722 is made on whether the user access privileges have been removed as requested. If the user access privileges have been removed, a report is generated at operation 724. One or more additional ticket processing loops can be performed until the user access privileges have been confirmed as removed and a final report is generated.

FIG. 8, FIG. 9, FIG. 10, and FIG. 11 illustrate example user interfaces (UIs) 800, 900, 1000, and 1100 which can be configured in connection with UAR automation using the UAR manager 134, according to some example embodiments. The example UIs 800, 900, 1000, and 1100 can be configured by the UAR manager 134 and displayed in connection with UAR functionalities associated with the UAR application 412.

Referring to FIG. 8, UI 800 is an example UI for the user access review portal used by a manager to track the status of their review and apply filters to optimize the UAR process. In some aspects, UI 800 includes progress report information 802 and list 803 (which is similar to list 508). For example, list 803 includes status information 804, user information 806, current access privileges or role information 808, and remediation action list 810. In some aspects, the remediation action list 810 is configured as a drop-down list 812 of remediation action options (e.g., “approved/keep” and “revoke this role” selection).

The UIs can be configured to request the manager to submit responses for each user-role combination. For any access removal, the UI can be configured to request additional information. For example and about UI 900, a manager can process list entry 904 from list 902 to revoke user role “ROLE 5” for user “USER 5”. After the revocation is requested via the drop-down list, additional information 906 and 908 is requested and can be used to supplement the review data table and the generated report.

In some aspects, when a role is aligned with RBAC data, the role can be displayed in a different color (e.g., green) and additional clarification information can be displayed next to the role. For example and about UI 1000, user role “ROLE 4” in entry 1002 is in alignment with RBAC data and additional information 1004 is provided when the manager hovers the mouse cursor over the “ROLE 4” entry. The additional information 1004 can be helpful and provide the manager with additional insights when they perform the review and helps them quickly identify outliers or exceptions.

In some aspects, the UAR manager 134 can configure a compliance portal for managing user access reviews periodically (e.g., each quarter). For example, the UAR manager 134 can configure a separate management portal for a security compliance team to track the completion of the user access review cycle and ensure that all reviews have been submitted timely and accurately. An example UI for the compliance portal is illustrated as UI 1100 in FIG. 11. Once the security compliance team reviews and validates all the reviews, such reviews can be submitted and audit records can be generated for retention and evidence for subsequent compliance audits. As seen in FIG. 11, UI 1100 can be configured to indicate the final count of submitted and validated reviews per system (or corporate department).

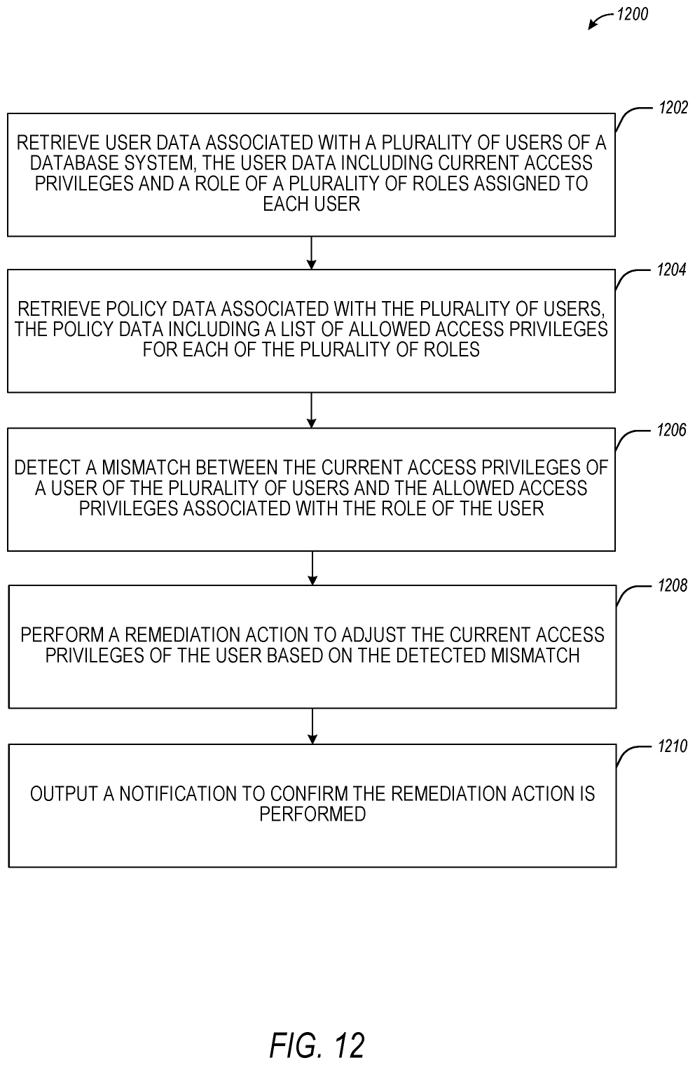

FIG. 12 is a flow diagram illustrating the operations of a database system in performing method 1200 for configuring user access review, according to some example embodiments. Method 1200 may be embodied in computer-readable instructions for execution by one or more hardware components (e.g., one or more processors) such that the operations of method 1200 may be performed by components of the network-based database system 102, such as a network node (e.g., a UAR manager 134 executing on a network node of the compute service manager 108) or a computing device (e.g., client device 114) which may be implemented as machine 1300 of FIG. 13 performing the disclosed functions. Accordingly, method 1200 is described below, by way of example with reference thereto. However, it shall be appreciated that method 1200 may be deployed on various other hardware configurations and is not intended to be limited to deployment within the network-based database system 102.

At operation 1202, user data associated with a plurality of users of a database system is retrieved. The user data includes current access privileges and a role of a plurality of roles assigned to each user of the plurality of users.

At operation 1204, policy data associated with the plurality of users is retrieved. The policy data includes a list of allowed access privileges for each of the plurality of roles.

At operation 1206, a mismatch between the current access privileges of a user of the plurality of users and the allowed access privileges associated with the role of the user is detected.

At operation 1208, a remediation action is performed to adjust the current access privileges of the user based on the detected mismatch.

At operation 1210, a notification (or a report) is generated and output to confirm the remediation action is performed.

FIG. 13 illustrates a diagrammatic representation of machine 1300 in the form of a computer system within which a set of instructions may be executed for causing machine 1300 to perform any one or more of the methodologies discussed herein, according to an example embodiment. Specifically, FIG. 13 shows a diagrammatic representation of machine 1300 in the example form of a computer system, within which instructions 1316 (e.g., software, a program, an application, an applet, an app, or other executable code) for causing the machine 1300 to perform any one or more of the methodologies discussed herein may be executed. For example, instructions 1316 may cause machine 1300 to execute any one or more operations of method 1200 (or any other technique discussed herein, for example in connection with FIG. 4-FIG. 11). As another example, instructions 1316 may cause machine 1300 to implement one or more portions of the functionalities discussed herein. In this way, instructions 1316 may transform a general, non-programmed machine into a particular machine 1300 (e.g., the client device 114, the compute service manager 108, or a node in the execution platform 110) that is specially configured to carry out any one of the described and illustrated functions in the manner described herein. In yet another embodiment, instructions 1316 may configure the client device 114, the compute service manager 108, and/or a node in the execution platform 110 to carry out any one of the described and illustrated functions in the manner described herein, which functions can be configured or performed by the UAR manager 134.

In alternative embodiments, the machine 1300 operates as a standalone device or may be coupled (e.g., networked) to other machines. In a networked deployment, machine 1300 may operate in the capacity of a server machine or a client machine in a server-client network environment, or as a peer machine in a peer-to-peer (or distributed) network environment. The machine 1300 may comprise, but not be limited to, a server computer, a client computer, a personal computer (PC), a tablet computer, a laptop computer, a netbook, a smartphone, a mobile device, a network router, a network switch, a network bridge, or any machine capable of executing the instructions 1316, sequentially or otherwise, that specify actions to be taken by the machine 1300. Further, while only a single machine 1300 is illustrated, the term “machine” shall also be taken to include a collection of machines 1300 that individually or jointly execute the instructions 1316 to perform any one or more of the methodologies discussed herein.

Machine 1300 includes processors 1310, memory 1330, and input/output (I/O) components 1350 configured to communicate with each other such as via a bus 1302. In some example embodiments, the processors 1310 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1312 and a processor 1314 that may execute the instructions 1316. The term “processor” is intended to include multi-core processors 1310 that may comprise two or more independent processors (sometimes referred to as “cores”) that may execute instructions 1316 contemporaneously. Although FIG. 13 shows multiple processors 1310, machine 1300 may include a single processor with a single core, a single processor with multiple cores (e.g., a multi-core processor), multiple processors with a single core, multiple processors with multiple cores, or any combination thereof.

The memory 1330 may include a main memory 1332, a static memory 1334, and a storage unit 1336, all accessible to the processors 1310 such as via the bus 1302. The main memory 1332, the static memory 1334, and the storage unit 1336 store the instructions 1316 embodying any one or more of the methodologies or functions described herein. The instructions 1316 may also reside, completely or partially, within the main memory 1332, within the static memory 1334, within machine storage medium 1338 of the storage unit 1336, within at least one of the processors 1310 (e.g., within the processor's cache memory), or any suitable combination thereof, during execution thereof by the machine 1300.

The I/O components 1350 include components to receive input, provide output, produce output, transmit information, exchange information, capture measurements, and so on. The specific I/O components 1350 that are included in a particular machine 1300 will depend on the type of machine. For example, portable machines such as mobile phones will likely include a touch input device or other such input mechanisms, while a headless server machine will likely not include such a touch input device. It will be appreciated that the I/O components 1350 may include many other components that are not shown in FIG. 13. The I/O components 1350 are grouped according to functionality merely for simplifying the following discussion and the grouping is in no way limiting. In various example embodiments, the I/O components 1350 may include output components 1352 and input components 1354. The output components 1352 may include visual components (e.g., a display such as a plasma display panel (PDP), a light-emitting diode (LED) display, a liquid crystal display (LCD), a projector, or a cathode ray tube (CRT)), acoustic components (e.g., speakers), other signal generators, and so forth. The input components 1354 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures or other tactile input components), audio input components (e.g., a microphone), and the like.

Communication may be implemented using a wide variety of technologies. The I/O components 1350 may include communication components 1364 operable to couple the machine 1300 to a network 1380 or devices 1370 via a coupling 1382 and a coupling 1372, respectively. For example, communication components 1364 may include a network interface component or another suitable device to interface with network 1380. In further examples, communication components 1364 may include wired communication components, wireless communication components, cellular communication components, and other communication components to provide communication via other modalities. The device 1370 may be another machine or any of a wide variety of peripheral devices (e.g., a peripheral device coupled via a universal serial bus (USB)). For example, as noted above, machine 1300 may correspond to any one of the client devices 114, the compute service manager 108, or the execution platform 110, and device 1370 may include the client device 114 or any other computing device described herein as being in communication with the network-based database system 102 or the cloud storage platform 104.

The various memories (e.g., 1330, 1332, 1334, and/or memory of the processor(s) 1310 and/or the storage unit 1336) may store one or more sets of instructions 1316 and data structures (e.g., software) embodying or utilized by any one or more of the methodologies or functions described herein. These instructions 1316, when executed by the processor(s) 1310, cause various operations to implement the disclosed embodiments.

As used herein, the terms “machine-storage medium,” “device-storage medium,” and “computer-storage medium” mean the same thing and may be used interchangeably in this disclosure. The terms refer to single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1380 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, network 1380 or a portion of network 1380 may include a wireless or cellular network, and coupling 1382 may be a Code Division Multiple Access (CDMA) connection, a Global System for Mobile communications (GSM) connection, or another type of cellular or wireless coupling. In this example, the coupling 1382 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1316 may be transmitted or received over the network 1380 using a transmission medium via a network interface device (e.g., a network interface component included in the communication components 1364) and utilizing any one of several well-known transfer protocols (e.g., hypertext transfer protocol (HTTP)). Similarly, instructions 1316 may be transmitted or received using a transmission medium via coupling 1372 (e.g., a peer-to-peer coupling or another type of wired or wireless network coupling) to device 1370. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1316 for execution by the machine 1300, and include digital or analog communications signals or other intangible media to facilitate communication of such software. Hence, the terms “transmission medium” and “signal medium” shall be taken to include any form of a modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the disclosed methods may be performed by one or more processors. The performance of certain operations may be distributed among the one or more processors, not only residing within a single machine but also deployed across several machines. In some example embodiments, the processor or processors may be located in a single location (e.g., within a home environment, an office environment, or a server farm), while in other embodiments the processors may be distributed across several locations.

Described implementations of the subject matter can include one or more features, alone or in combination as illustrated below by way of examples.

Example 1 is a system comprising: at least one hardware processor; and at least one memory storing instructions that cause the at least one hardware processor to perform operations comprising: retrieving user data associated with a plurality of users of a database system, the user data including current access privileges and a role of a plurality of roles assigned to each user of the plurality of users; retrieving policy data associated with the plurality of users, the policy data including a list of allowed access privileges for each of the plurality of roles; detecting a mismatch between the current access privileges of a user of the plurality of users and the allowed access privileges associated with the role of the user; performing a remediation action to adjust the current access privileges of the user based on the detected mismatch; and outputting a notification to confirm the remediation action is performed.

In Example 2, the subject matter of Example 1 includes, the operations further comprising: ingesting the user data and the policy data into a shared database of a network-based database system to obtain ingested data; performing data transformation of the ingested data using at least one user-defined function to obtain transformed data; and detecting the mismatch using the transformed data.

In Example 3, the subject matter of Example 2 includes, the operations further comprising: retrieving role-based access control (RBAC) data of the network-based database system; and retrieving the policy data using the RBAC data.

In Example 4, the subject matter of Examples 1-3 includes, the operations further comprising: configuring a first user interface, the first user interface to display a first list of the plurality of users, and a second list with the role of the plurality of roles assigned to each user of the plurality of users.

In Example 5, the subject matter of Example 4 includes, the operations further comprising: modifying the display of one or more roles of the plurality of roles in the second list based on detecting the mismatch between the current access privileges and the allowed access privileges.

In Example 6, the subject matter of Examples 4-5 includes, the operations further comprising: modifying the first user interface to include a plurality of remediation actions corresponding to the mismatch.

In Example 7, the subject matter of Example 6 includes, the operations further comprising: detecting input via the first user interface, the input indicating a selection of the remediation action from the plurality of remediation actions; and modifying the first user interface to further include lookback information associated with the selection of the remediation action.

In Example 8, the subject matter of Example 7 includes subject matter for the lookback information indicating whether the current access privileges of the user support the role of the plurality of roles assigned to the user.

In Example 9, the subject matter of Examples 7-8 includes, the operations further comprising: configuring a second user interface including selections for each of the plurality of remediation actions, and the selections received via the first user interface.

In Example 10, the subject matter of Examples 1-9 includes subject matter for performing the remediation action further comprising: performing a revocation of the current access privileges of the user based on detecting the mismatch; and generating a report listing the revocation.

Example 11 is a method comprising: retrieving, by at least one hardware processor, user data associated with a plurality of users of a database system, the user data including current access privileges, and a role of a plurality of roles assigned to each user of the plurality of users; retrieving, by the at least one hardware processor, policy data associated with the plurality of users, the policy data including a list of allowed access privileges for each of the plurality of roles; detecting, by at least one hardware processor, a mismatch between the current access privileges of a user of the plurality of users and the allowed access privileges associated with the role of the user; performing a remediation action to adjust the current access privileges of the user based on the detected mismatch; and outputting a notification to confirm the remediation action is performed.

In Example 12, the subject matter of Example 11 includes subject matter for ingesting the user data and the policy data into a shared database of a network-based database system to obtain ingested data; performing data transformation of the ingested data using at least one user-defined function to obtain transformed data; and detecting the mismatch using the transformed data.

In Example 13, the subject matter of Example 12 includes subject matter for retrieving role-based access control (RBAC) data of the network-based database system; and retrieving the policy data using the RBAC data.

In Example 14, the subject matter of Examples 11-13 includes subject matter for configuring a first user interface, the first user interface to display a first list of the plurality of users and a second list with the role of the plurality of roles assigned to each user of the plurality of users.

In Example 15, the subject matter of Example 14 includes subject matter for modifying the display of one or more roles of the plurality of roles in the second list based on detecting the mismatch between the current access privileges and the allowed access privileges.

In Example 16, the subject matter of Examples 14-15 includes subject matter for modifying the first user interface to include a plurality of remediation actions corresponding to the mismatch.

In Example 17, the subject matter of Example 16 includes subject matter for detecting input via the first user interface, the input indicating a selection of the remediation action from the plurality of remediation actions, and modifying the first user interface to further include lookback information associated with the selection of the remediation action.

In Example 18, the subject matter of Example 17 includes subject matter for the lookback information indicating whether the current access privileges of the user support the role of the plurality of roles assigned to the user.

In Example 19, the subject matter of Examples 17-18 includes subject matter for configuring a second user interface including selections for each of the plurality of remediation actions, the selections received via the first user interface.

In Example 20, the subject matter of Examples 11-19 includes subject matter for performing the remediation action further comprises: performing a revocation of the current access privileges of the user based on detecting the mismatch; and generating a report listing the revocation.

Example 21 is a computer-storage medium comprising instructions that, when executed by one or more processors of a machine, configure the machine to perform operations comprising: retrieving user data associated with a plurality of users of a database system, the user data including current access privileges and a role of a plurality of roles assigned to each user of the plurality of users; retrieving policy data associated with the plurality of users, the policy data including a list of allowed access privileges for each of the plurality of roles; detecting a mismatch between the current access privileges of a user of the plurality of users and the allowed access privileges associated with the role of the user; performing a remediation action to adjust the current access privileges of the user based on the detected mismatch; and outputting a notification to confirm the remediation action is performed.

In Example 22, the subject matter of Example 21 includes, the operations further comprising: ingesting the user data and the policy data into a shared database of a network-based database system to obtain ingested data; performing data transformation of the ingested data using at least one user-defined function to obtain transformed data; and detecting the mismatch using the transformed data.

In Example 23, the subject matter of Example 22 includes, the operations further comprising: retrieving role-based access control (RBAC) data of the network-based database system; and retrieving the policy data using the RBAC data.

In Example 24, the subject matter of Examples 21-23 includes, the operations further comprising: configuring a first user interface, the first user interface to display a first list of the plurality of users, and a second list with the role of the plurality of roles assigned to each user of the plurality of users.

In Example 25, the subject matter of Example 24 includes, the operations further comprising: modifying the display of one or more roles of the plurality of roles in the second list based on detecting the mismatch between the current access privileges and the allowed access privileges.

In Example 26, the subject matter of Examples 24-25 includes, the operations further comprising: modifying the first user interface to include a plurality of remediation actions corresponding to the mismatch.

In Example 27, the subject matter of Example 26 includes, the operations further comprising: detecting input via the first user interface, the input indicating a selection of the remediation action from the plurality of remediation actions; and modifying the first user interface to further include lookback information associated with the selection of the remediation action.

In Example 28, the subject matter of Example 27 includes subject matter for the lookback information indicating whether the current access privileges of the user support the role of the plurality of roles assigned to the user.

In Example 29, the subject matter of Examples 27-28 includes, the operations further comprising: configuring a second user interface including selections for each of the plurality of remediation actions, and the selections received via the first user interface.

In Example 30, the subject matter of Examples 21-29 includes subject matter for performing the remediation action further comprising: performing a revocation of the current access privileges of the user based on detecting the mismatch; and generating a report listing the revocation.

Example 31 is at least one machine-readable medium including instructions that, when executed by processing circuitry, cause the processing circuitry to perform operations to implement any of Examples 1-30.

Example 32 is an apparatus comprising means to implement any of Examples 1-30.

Example 33 is a system to implement any of Examples 1-30.

Example 34 is a method to implement any of Examples 1-30.

Although the embodiments of the present disclosure have been described concerning specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is disclosed. Thus, although specific embodiments have been illustrated and described herein, it should be appreciated that any arrangement calculated to achieve the same purpose may be substituted for the specific embodiments shown. This disclosure is intended to cover any adaptations or variations of various embodiments. Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
at least one memory storing instructions that cause the at least one hardware processor to perform operations comprising:
retrieving user data associated with a plurality of users of a database system, the user data including current access privileges and a role of a plurality of roles assigned to each user of the plurality of users;
retrieving policy data associated with the plurality of users, the policy data including a list of allowed access privileges for each of the plurality of roles;
detecting a mismatch between the current access privileges of a user of the plurality of users and the allowed access privileges associated with the role of the user;
performing a remediation action to adjust the current access privileges of the user based on the detected mismatch; and
outputting a notification to confirm the remediation action is performed.

2. The system of claim 1, the operations further comprising:
ingesting the user data and the policy data into a shared database of a network-based database system to obtain ingested data;
performing data transformation of the ingested data using at least one user-defined function to obtain transformed data; and
detecting the mismatch using the transformed data.

3. The system of claim 2, the operations further comprising:
retrieving role-based access control (RBAC) data of the network-based database system; and
retrieving the policy data using the RBAC data.

4. The system of claim 1, the operations further comprising:
configuring a first user interface, the first user interface to display a first list of the plurality of users and a second list with the role of the plurality of roles assigned to each user of the plurality of users.

5. The system of claim 4, the operations further comprising:
modifying the display of one or more roles of the plurality of roles in the second list based on detecting the mismatch between the current access privileges and the allowed access privileges.

6. The system of claim 4, the operations further comprising:
modifying the first user interface to include a plurality of remediation actions corresponding to the mismatch.

7. The system of claim 6, the operations further comprising:
detecting input via the first user interface, the input indicating a selection of the remediation action from the plurality of remediation actions; and
modifying the first user interface to further include lookback information associated with the selection of the remediation action.

8. The system of claim 7, wherein the lookback information indicates whether the current access privileges of the user support the role of the plurality of roles assigned to the user.

9. The system of claim 7, the operations further comprising:
configuring a second user interface including selections for each of the plurality of remediation actions, the selections received via the first user interface.

10. The system of claim 1, the operations for performing the remediation action further comprising:
performing a revocation of the current access privileges of the user based on detecting the mismatch; and
generating a report listing the revocation.

11. A method comprising:
retrieving, by at least one hardware processor, user data associated with a plurality of users of a database system, the user data including current access privileges and a role of a plurality of roles assigned to each user of the plurality of users;
retrieving, by the at least one hardware processor, policy data associated with the plurality of users, the policy data including a list of allowed access privileges for each of the plurality of roles;
detecting, by at least one hardware processor, a mismatch between the current access privileges of a user of the plurality of users and the allowed access privileges associated with the role of the user;
performing a remediation action to adjust the current access privileges of the user based on the detected mismatch; and
outputting a notification to confirm the remediation action is performed.

12. The system of claim 11, the method further comprising:
ingesting the user data and the policy data into a shared database of a network-based database system to obtain ingested data;
performing data transformation of the ingested data using at least one user-defined function to obtain transformed data; and
detecting the mismatch using the transformed data.

13. The system of claim 12, the method further comprising:
retrieving role-based access control (RBAC) data of the network-based database system; and
retrieving the policy data using the RBAC data.

14. The system of claim 11, the method further comprising:
configuring a first user interface, the first user interface to display a first list of the plurality of users and a second list with the role of the plurality of roles assigned to each user of the plurality of users.

15. The system of claim 14, the method further comprising:
modifying the display of one or more roles of the plurality of roles in the second list based on detecting the mismatch between the current access privileges and the allowed access privileges.

16. The system of claim 14, the method further comprising:
modifying the first user interface to include a plurality of remediation actions corresponding to the mismatch.

17. The system of claim 16, the method further comprising:
detecting input via the first user interface, the input indicating a selection of the remediation action from the plurality of remediation actions; and
modifying the first user interface to further include lookback information associated with the selection of the remediation action.

18. The system of claim 17, wherein the lookback information indicates whether the current access privileges of the user support the role of the plurality of roles assigned to the user.

19. The system of claim 17, the method further comprising:
configuring a second user interface including selections for each of the plurality of remediation actions, the selections received via the first user interface.

20. The system of claim 11, wherein performing the remediation action further comprises:
performing a revocation of the current access privileges of the user based on detecting the mismatch; and
generating a report listing the revocation.

21. A computer-storage medium comprising instructions that, when executed by one or more processors of a machine, configure the machine to perform operations comprising:
retrieving user data associated with a plurality of users of a database system, the user data including current access privileges and a role of a plurality of roles assigned to each user of the plurality of users;
retrieving policy data associated with the plurality of users, the policy data including a list of allowed access privileges for each of the plurality of roles;
detecting a mismatch between the current access privileges of a user of the plurality of users and the allowed access privileges associated with the role of the user;
performing a remediation action to adjust the current access privileges of the user based on the detected mismatch; and
outputting a notification to confirm the remediation action is performed.

22. The computer-storage medium of claim 21, the operations further comprising:
ingesting the user data and the policy data into a shared database of a network-based database system to obtain ingested data;
performing data transformation of the ingested data using at least one user-defined function to obtain transformed data; and
detecting the mismatch using the transformed data.

23. The computer-storage medium of claim 22, the operations further comprising:
retrieving role-based access control (RBAC) data of the network-based database system; and
retrieving the policy data using the RBAC data.

24. The computer-storage medium of claim 21, the operations further comprising:
configuring a first user interface, the first user interface to display a first list of the plurality of users and a second list with the role of the plurality of roles assigned to each user of the plurality of users.

25. The computer-storage medium of claim 24, the operations further comprising:
modifying the display of one or more roles of the plurality of roles in the second list based on detecting the mismatch between the current access privileges and the allowed access privileges.

26. The computer-storage medium of claim 24, the operations further comprising:
modifying the first user interface to include a plurality of remediation actions corresponding to the mismatch.

27. The computer-storage medium of claim 26, the operations further comprising:
detecting input via the first user interface, the input indicating a selection of the remediation action from the plurality of remediation actions; and
modifying the first user interface to further include lookback information associated with the selection of the remediation action.

28. The computer-storage medium of claim 27, wherein the lookback information indicates whether the current access privileges of the user support the role of the plurality of roles assigned to the user.

29. The computer-storage medium of claim 27, the operations further comprising:
configuring a second user interface including selections for each of the plurality of remediation actions, the selections received via the first user interface.

30. The computer-storage medium of claim 21, the operations for performing the remediation action further comprising:
performing a revocation of the current access privileges of the user based on detecting the mismatch; and
generating a report listing the revocation.
